(19) United States
(12) Patent Application Publication
(10) Pub. No.: US 2025/0390465 A1
(43) Pub. Date: Dec. 25, 2025

(54) Space Provision System, Server, and Space Provision Method

(71) Applicant: SHIMADZU CORPORATION, Kyoto-shi (JP)

(72) Inventors: Jun KAWAI, Kyoto-shi (JP); Tomoya SUGIE, Kyoto-shi (JP); Ryo TAKEGAWA, Kyoto-shi (JP)

(21) Appl. No.: 19/248,114

(22) Filed: Jun. 24, 2025

(30) Foreign Application Priority Data
Jun. 24, 2024 (JP) 2024-100919

(51) Int. Cl. G06F 16/14; G06F 3/04815

(52) U.S. Cl. CPC G06F 16/156; G06F 16/148; G06F 3/04815

(57) ABSTRACT

A service provision system includes a plurality of user apparatuses used by a plurality of users, and a server. The server is configured to arrange a plurality of data file objects corresponding to a plurality of data files in a virtual space, arrange a plurality of user objects respectively corresponding to the plurality of users, obtain search information for searching for a specific data file from the plurality of data files, determine a reference position based on positions of the plurality of user objects, and based on the determined reference position and an evaluation value for search information in each of the plurality of data files, determine a manner of displaying the plurality of data file objects to be arranged.

### CROSS REFERENCE TO RELATED APPLICATIONS

This nonprovisional application is based on Japanese Patent Application No. 2024-100919 filed on Jun. 24, 2024 with the Japan Patent Office, the entire contents of which are hereby incorporated by reference.

### BACKGROUND OF THE INVENTION

### Field of the Invention

The present disclosure relates to a space provision system, a server, and a space provision method.

### Description of the Background Art

A system has conventionally been known that displays documents that are search results from a large number of search targets based on a search query input by a user. For example, Japanese Patent No. 7167997 discloses a document search system in which a user performs retrieval for determining analysis relevant preprocessing, an analysis relevant device name, an analysis method, an analysis relevant compound name, and an analysis relevant analysis target name. In the document search system of Japanese Patent No. 7167997, technical documents such as analysis reports, technical reports, technical papers, and research papers are the search targets.

### SUMMARY OF THE INVENTION

The document search system disclosed in Japanese Patent No. 7167997 is a system directed to a case for use by one user. However, document viewing may be required also during a discussion among a plurality of people. The document search system disclosed in Japanese Patent No. 7167997 may be said to have room for improvement when considering a case where a plurality of people are viewing technical documents while conducting a discussion.

In recent years, a technology called “metaverse” that allows users to interact with others via avatars in a three-dimensional virtual space has been actively used. If a plurality of users can use such a metaverse to search for and view data files while sharing a plurality of data files in the same virtual space, user's convenience when a plurality of people are viewing documents while conducting a discussion can be improved.

The present disclosure has been made to solve the problem described above. An object of the present disclosure is to provide a technology of allowing data files, which have been searched for by a user, to be viewed in a more easy-to-understand manner in a virtual space, thereby improving user's convenience when the user searches for documents while conducting a discussion among a plurality of people.

A space provision system of the present disclosure is a space provision system configured to provide a virtual space to a plurality of users. The space provision system includes a plurality of user apparatuses respectively used by the plurality of users, and a server that provides the virtual space to the plurality of user apparatuses. The server is configured to arrange a plurality of data file objects respectively corresponding to a plurality of data files in the virtual space, arrange a plurality of user objects respectively corresponding to the plurality of users in the virtual space, obtain search information for searching for a specific data file from the plurality of data files, determine a reference position based on positions of the plurality of user objects, and based on the determined reference position and an evaluation value for search information in each of the plurality of data files, determine a manner of displaying the plurality of data file objects to be arranged.

A server of the present disclosure is a server configured to provide a virtual space to a plurality of user apparatuses respectively used by a plurality of users. The server includes a storage device configured to store a plurality of data files, and a control unit configured to control an object arranged in the virtual space. The control unit is configured to arrange a plurality of data file objects respectively corresponding to a plurality of data files in the virtual space, arrange a plurality of user objects respectively corresponding to the plurality of users in the virtual space, obtain search information for searching for a specific data file from the plurality of data files, determine a reference position based on positions of the plurality of user objects, and based on the determined reference position and an evaluation value for search information in each of the plurality of data files, determine a manner of displaying the plurality of data file objects to be arranged.

A space provision method of the present disclosure is a space provision method of providing a virtual space to a plurality of user apparatuses respectively used by a plurality of users. The space provision method includes, as processing to be performed by a computer: arranging a plurality of data file objects respectively corresponding to a plurality of data files in the virtual space; arranging a plurality of user objects respectively corresponding to the plurality of users in the virtual space; obtaining search information for searching for a specific data file from the plurality of data files; and determining a reference position based on positions of the plurality of user objects, and based on the determined reference position and an evaluation value for search information in each of the plurality of data files, determining a manner of displaying the plurality of data file objects to be arranged.

A space provision program of the present disclosure is a space provision program that provides a virtual space to a plurality of user apparatuses respectively used by a plurality of users. The space provision program causes a computer to: arrange a plurality of data file objects respectively corresponding to a plurality of data files in the virtual space; arrange a plurality of user objects respectively corresponding to the plurality of users in the virtual space; obtain search information for searching for a specific data file from the plurality of data files; and determine a reference position based on positions of the plurality of user objects, and based on the determined reference position and an evaluation value for search information in each of the plurality of data files, determine a manner of displaying the plurality of data file objects to be arranged.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic configuration of a space provision system according to Embodiment 1.

FIG. 2 is a block diagram showing components included in the space provision system.

FIG. 3 shows an example virtual space in Embodiment 1.

FIG. 4 is a diagram for illustrating an arrangement of objects as search results in Embodiment 1.

FIG. 5 shows an example of determining a manner of displaying data files in Embodiment 1.

FIG. 6 is a flowchart for illustrating a procedure of arranging data file objects in Embodiment 1.

FIG. 7 is a diagram for illustrating an arrangement of objects as search results in Embodiment 2.

FIG. 8 is a flowchart for illustrating a procedure of arranging data file objects in Embodiment 2.

FIG. 9 is a flowchart for illustrating a procedure of arranging data file objects in Embodiment 3.

FIG. 10 is a diagram for illustrating an arrangement of objects as search results in Embodiment 4.

FIG. 11 shows an example of determining a manner of displaying data files in Embodiment 5.

FIG. 12 is a flowchart for illustrating a procedure of arranging data file objects in Embodiment 5.

FIG. 13 shows an example of determining positions at which data file objects are arranged in a modification of Embodiment 2.

### DESCRIPTION OF THE PREFERRED EMBODIMENTS

### Embodiment 1

The present embodiments will be described in detail with reference to the drawings. The same or corresponding parts have the same reference characters allotted, and description thereof will not be repeated in principle.

### <Overall Configuration of Space Provision System>

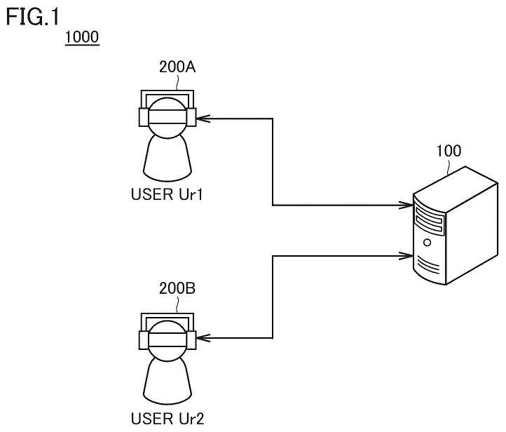

FIG. 1 shows a schematic configuration of a space provision system 1000 according to Embodiment 1. Space provision system 1000 is a system for providing a virtual space to a plurality of users Ur1, Ur2. Space provision system 1000 includes a server 100, a user apparatus 200A, and a user apparatus 200B. User apparatuses 200A, 200B are worn by users Ur1, Ur2, respectively. In the example of FIG. 1, two users, Ur1, Ur2, are illustrated as a plurality of users, but two or more users can participate in the virtual space provided by space provision system 1000.

Server 100 holds data necessary for configuring a virtual space and manages the virtual space. Server 100 transmits, to user apparatuses 200A, 200B, information for providing the virtual space to users Ur1, Ur2. User apparatuses 200A, 200B display the virtual space to users Ur1, Ur2, respectively, based on the information received from server 100. In the present embodiment, the configuration of user apparatus 200A is similar to the configuration of user apparatus 200B. Hereinafter, user apparatus 200A and user apparatus 200B are collectively referred to as “user apparatus 200”.

User apparatus 200 is, for example, a head-mounted display (HMD). The user wears user apparatus 200 on the head and is immersed in the virtual space. In the present embodiment, user Ur1 and user Ur2 are located at different positions. Space provision system 1000 provides the same virtual space to users Ur1, Ur2, causing users Ur1, Ur2 to perceive as if users Ur1, Ur2 were in the same space. Thus, space provision system 1000 can facilitate communication between users Ur1, Ur2 by providing the same virtual space.

In the present embodiment, user Ur1 is an employee of a company that manages server 100. On the other hand, user Ur2 is an employee of another company that does business with the company that manages server 100. In other words, user Ur1 and user Ur2 belong to different organizations. The following will describe an example in which users Ur1, Ur2 are both researchers and user Ur1 and user Ur2 exchange opinions about their research in a virtual space. As will be described later in detail, user Ur1 shares data files such as a plurality of technical documents of his/her company stored on server 100 of his/her company with user Ur2 of the other company in the virtual space.

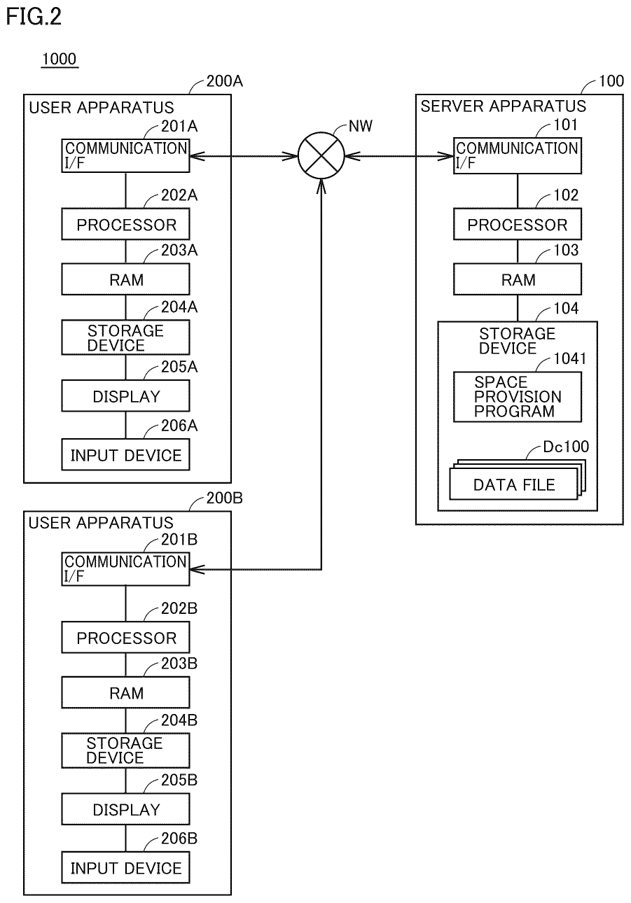

FIG. 2 is a block diagram showing components included in space provision system 1000. Server 100 and user apparatuses 200A, 200B are connected to each other for communication via a network NW. Network NW is typically the Internet. Server 100 includes a communication interface (I/F) 101, a processor 102, a random access memory (RAM) 103, and a storage device 104. Communication interface 101, processor 102, RAM 103, and storage device 104 are connected to a common bus and are configured to be able to exchange signals with each other.

Processor 102 is a computing entity (computer) that performs various types of processing by executing various programs. Processor 102 includes, for example, a central processing unit (CPU), a micro-processing unit (MPU), or the like. Processor 102 has the function of performing various types of processing by executing programs, but some or all of these functions may be implemented by a field programmable gate array (FPGA), an application-specific integrated circuit (ASIC), or the like. The term “processor” is not limited to a processor in a narrow sense that performs processing in the form of stored program, such as CPU or MPU, and may include a hardwired circuit such as ASIC or FPGA.

Thus, processor 102 can also be read as processing circuitry in which processing is predefined by a computer-readable code and/or a hardwired circuit. Processor 102 may include a single chip or a plurality of chips. Further, processor 102 and related processing circuitry may include a plurality of computers interconnected through wires or wirelessly over a local area network, a wireless network, or the like. Processor 102 and related processing circuitry may include a cloud computer that computes remotely based on input data and outputs computation results to any other device located at a remote position.

RAM 103 is a transitory storage medium used to store, for example, computation results by processor 102. Storage device 104 is a memory such as read only memory (ROM) or a non-transitory storage medium such as hard disc drive (HDD) or solid state drive (SSD). Storage device 104 stores a space provision program 1041 executed by CPU 102, and a data file group Dc100. Storage device 104 may be used as a transitory buffer space for storing computation results by CPU 102 or the like, similarly to RAM 103.

Data file group Dc100 is a set of a plurality of data files that are search targets in the present embodiment. Data file group Dc100 includes, for example, data files of a plurality of technical documents. In the present embodiment, data file group Dc100 includes data files of 100 technical documents.

In the present embodiment, user apparatus 200A includes a communication interface (I/F) 201A, a processor 202A, a RAM 203A, a storage device 204A, a display 205A, and an input device 206A. The configurations of communication interface 201A, processor 202A, RAM 203A, and storage device 204A in user apparatus 200A are the same as the configurations of communication interface 101, processor 102, RAM 103, and storage device 104 in server 100, description of which will not be repeated.

User apparatus 200A is a head-mounted display that is worn on the head of user Ur1 and shows a virtual space to user Ur1 by covering both eyes of user Ur1 with display 205A. FIG. 2 shows an example in which processor 202A, RAM 203A, and storage device 204A are built in user apparatus 200A, but in one aspect, processor 202A, RAM 203A, and storage device 204A may be provided separately from user apparatus 200A. For example, processor 202A, RAM 203A, and storage device 204A may be provided inside a general-purpose PC connected to the head-mounted display. User apparatus 200A may include a speaker for listening to the voice of any other user or music in the virtual space.

Input device 206A may be, for example, a virtual keyboard (software keyboard) or a microphone for obtaining the content of an utterance by the user. The virtual keyboard is an object that has the shape of a keyboard arranged in the virtual space, and user Ur1 operates the virtual keyboard arranged in the virtual space. User Ur1 can send an instruction to server 100 while wearing the head-mounted display. Input device 206A may include a keyboard or a mouse that exists in the real world, or may include a motion capture sensor for detecting that the virtual keyboard has been operated.

User apparatus 200B includes a communication interface (I/F) 201B, a processor 202B, a RAM 203B, a storage device 204B, a display 205B, and an input device 206B. Each of the components included in user apparatus 200B has the same configuration as each of the components included in user apparatus 200A, description of which will not be repeated.

### <Virtual Space>

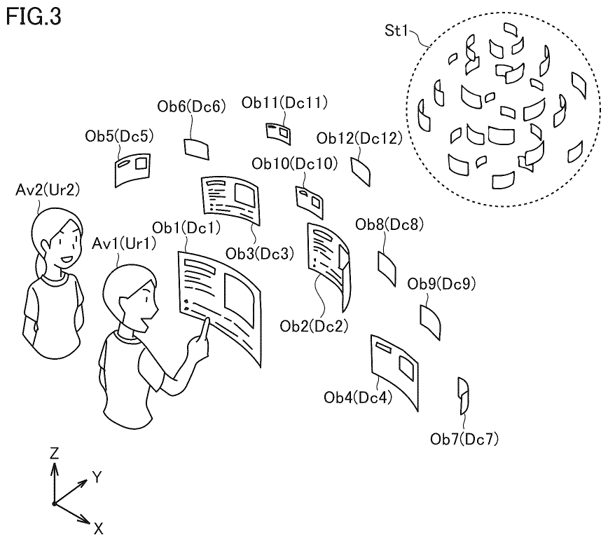

FIG. 3 shows an example virtual space in Embodiment 1. FIG. 3 shows the state after the search results have become available for viewing based on the fact that user Ur1 has searched for data files. The virtual space is a three-dimensional space with an X axis, a Y axis, and a Z axis orthogonal to one another. In the following, the positive direction of the Z axis may be referred to as the “upward direction”, and the negative direction of the Z axis may be referred to as the “downward direction”.

FIG. 3 shows a plurality of objects arranged in a virtual space. A plurality of user objects respectively corresponding to a plurality of users are arranged in the virtual space. In the example of FIG. 3, in the virtual space, an avatar Av1 corresponding to user Ur1 and an avatar Av2 corresponding to user Ur2 are arranged. Avatars Av1, Av2 are objects each having a shape that resembles a human.

Avatar Av1 is arranged while facing the positive direction side of the Y axis. Server 100 shows, via display 205A, user Ur1 a view of the virtual space on the positive direction side of the Y axis as seen from the position of avatar Av1. In other words, user Ur1 shares the field of view of avatar Av1 in the virtual space. Similarly, user Ur2 shares the field of view of avatar Av2 in the virtual space. As a result, users Ur1, Ur2 can perceive as if they themselves were present in the virtual space.

As described above, users Ur1, Ur2 exchange opinions about their research in the virtual space. In the virtual space, users Ur1, Ur2 exchange opinions while viewing the same technical document, leading to a more active discussion. User Ur1 accesses storage device 104 of server 100 and searches for technical documents that are effective for exchanging opinions from the technical documents owned by the company to which user Ur1 belongs.

Specifically, user Ur1 inputs, as a keyword, a word that may be included in the data file desired by user Ur1 to input device 206A. User apparatus 200A transmits, to server 100, the keyword input by user Ur1. Server 100 searches for data files that satisfy a keyword search condition from data file group Dc100 based on the keyword input by user Ur1. The keyword in Embodiment 1 may correspond to the “search information” in the present disclosure.

The keyword search condition is whether the degree of association of a data file with an input keyword is higher than a predetermined threshold. As shown in FIG. 3, the data files that satisfy the keyword search condition are displayed in front of avatar Av1. In the example of FIG. 3, 12 data files Dc1 to Dc12 are displayed as data files that satisfy the keyword search condition.

Server 100 calculates an evaluation value for search information in each of the 100 data files included in data file group Dc100. In Embodiment 1, the evaluation value is calculated as a degree of association with the keyword. In other words, server 100 of Embodiment 1 calculates the degree of association with the keyword for each of the 100 data files included in data file group Dc100. The degree of association with the keyword is calculated from, for example, the number of words that are identical to the keyword included in the data file, the number of words similar to the keyword included in the data file, the attribute information that is associated with the data file in advance, or the like. Server 100 calculates the degree of association of the data file including a plurality of words identical to the keyword in the document to be higher than the degree of association of the data file including no words identical to the keyword in the document. The algorithm for calculating a degree of association may be any other algorithm.

Server 100 changes the manner of displaying each of the 100 data files included in data file group Dc100 in accordance with the calculated degree of association. Server 100 arranges the data file object corresponding to the data file having a degree of association greater than or equal to a predetermined threshold in front of avatar Av1 corresponding to user Ur1 who is a searcher. The data file having a degree of association greater than or equal to the threshold may be referred to as a “search result” below.

FIG. 3 shows data file objects Ob1 to Ob12 corresponding to data files Dc1 to Dc12. Each of data file objects Ob1 to Ob12 is arranged at a predetermined distance from avatar Av1 in the XY plane. The distances between data file object Ob1 to Ob12 and avatar Av1 are different from one another. As shown in FIG. 3, when the data file object is displayed as a search result, the data file object is displayed such that user Ur1 can recognize the document content of the data file.

On the other hand, server 100 collects and arranges data file objects corresponding to data files each having a degree of association value less than a predetermined threshold within a range St1. Range St1 is arranged on the positive direction side of the Y axis from the position of avatar Av1, and data file object Ob1 is arranged between range St1 and avatar Av1. In other words, range St1 is located in the background of the virtual space as seen from user Ur1.

Thus, in space provision system 1000 of the present embodiment, a plurality of data file objects are displayed within range St1 as the background for data file objects Ob1 to Ob12 displayed as search results. In the example of Embodiment 1, 88 data file objects are collected within range St1. As a result, space provision system 1000 can express the number of technical documents owned by the company to which user Ur1 belongs in three dimensions in the virtual space, and can visualize the technical capabilities of the company. User Ur2, who belongs to an organization different from the company to which user Ur1 belongs, can easily recognize the technical capabilities of the company to which user Ur1 belongs from the number of data file objects included in range St1.

### <Arrangement of Objects as Search Results>

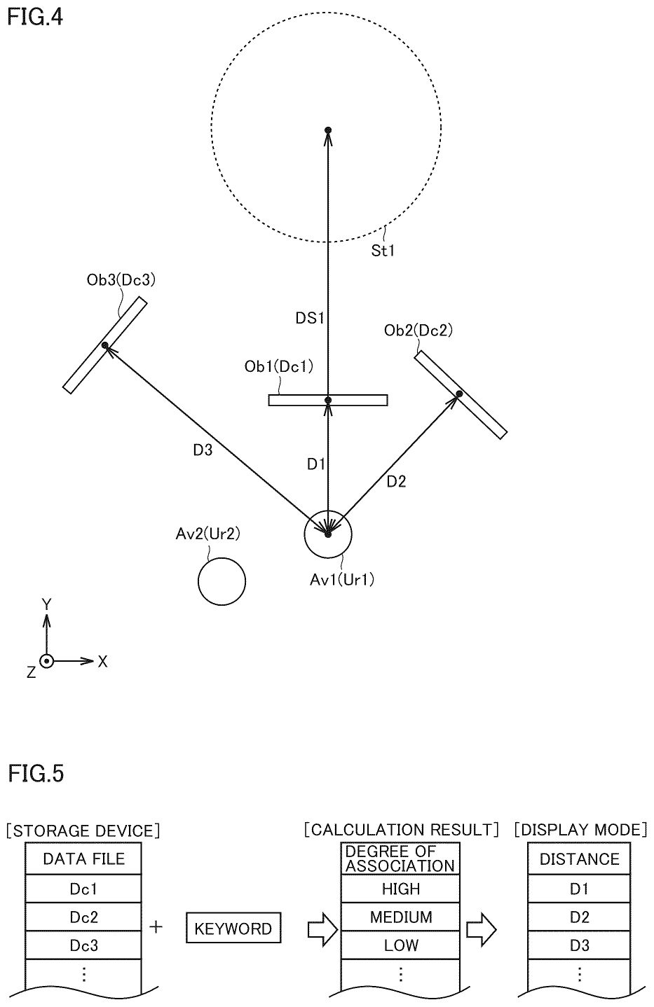

The arrangement of data file objects Ob1 to Ob12 displayed as search results will be described below with reference to FIG. 4. FIG. 4 is a diagram for illustrating the arrangement of objects as search results in Embodiment 1. FIG. 4 shows a diagram in which avatars Av1, Av2, data file objects Ob1 to Ob3, and range St1 are viewed from above (the positive direction side of the Z axis) in the virtual space. In FIG. 4, data file objects Ob4 to Ob12 are not shown.

FIG. 4 shows distances between data file objects and avatar Av1 corresponding to user Ur1 who is a searcher. The straight-line distance between the position of avatar Av1 and the position of data file object Ob1 is a distance D1. The straight-line distance between the position of avatar Av1 and the position of data file object Ob2 is a distance D2. The straight-line distance between the position of avatar Av1 and the position of data file object Ob3 is a distance D3. The straight-line distance between the position of avatar Av1 and the position of range St1 is a distance DS1.

As shown in FIG. 4, of distances D1 to D3 and DS1, distance D1 is the shortest, and distance DS1 is the longest. Distance D3 is longer than distance D1 and distance D2 and is shorter than distance DS1. Distance D2 is longer than distance D1 and is shorter than distance D3 and distance DS1.

Server 100 calculates the degree of association with a keyword for all data files in data file group Dc100, and based on the calculated degree of association, determines whether to arrange the data files as search results or arrange the data files within range St1. Further, server 100 determines the details of the arrangement of data file objects Ob1 to Ob12, which are displayed as search results, based on the magnitude of the degrees of association of data file objects Ob1 to Ob12.

Specifically, server 100 arranges a data file having a high degree of association near avatar Av1, and arranges a data file having a low degree of association at a position remote from avatar Av1. In other words, server 100 arranges a data file object having a high degree of association at a position closer to avatar Av1 than a data file object having a low degree of association.

In the example of FIG. 4, of data file group Dc100, data file Dc1 is a data file having the highest degree of association with the keyword. Data file Dc2 is a data file having the second highest degree of association, following data file Dc1. Thus, data file object Ob1 is arranged at a position closest to avatar Av1 among other data file objects. Data file object Ob2 is arranged at a position that is the second closest to data file object Ob1, following data file object Ob1. In the example of FIG. 4, data file objects Ob1 to Ob3 are arranged relative to the position of avatar Av1. In space provision system 1000 in one aspect, when the distance between avatar Av1 and avatar Av2 is greater than or equal to a predetermined distance determined in advance, data file objects Ob1 to Ob3 may be displayed relative to the position of any of avatars Av1, Av2. This allows space provision system 1000 to arrange data file objects Ob1 to Ob3 at highly visible positions, at least as seen from the position of avatar Av1.

Thus, space provision system 1000 arranges each data file object such that data file objects are displayed in manners different from one another in accordance with the calculated degrees of association. Data file object Ob1 may correspond to the “first data file object” in the present disclosure. Data file object Ob2 may correspond to the “second data file object” in the present disclosure. Data file Dc1 may correspond to the “first data file” in the present disclosure. Data file Dc2 may correspond to the “second data file” in the present disclosure. Avatar Av1 may correspond to the “first user object” in the present disclosure.

FIG. 5 shows an example of determining a manner of displaying data files Dc1 to Dc12 in Embodiment 1. Storage device 104 stores, as data file group Dc100, a database with the name of a data file as a primary key. Server 100 calculates the degree of association between each of the 100 data files included in data file group Dc100 and the keyword.

FIG. 5 shows calculation results of degrees of association of data files in the example of Embodiment 1. The degree of association of data file Dc1 with the keyword is “high”, the degree of association of data file Dc2 with the keyword is “medium”, and the degree of association of data file Dc3 with the keyword is “low”. In the example of FIG. 5, the degree of association is denoted as “high”, “medium”, or “low” for simplicity of description, but in actuality, the value calculated as the degree of association is a numerical value.

Server 100 changes the manner of displaying data files in the virtual space using the calculated degrees of association. Specifically, server 100 arranges data file object Ob1, which has the highest degree of association, at a position remote from avatar Av1 by distance D1. Server 100 arranges data file object Ob2, which has the second highest degree of association, at a position remote from avatar Av1 by distance D2. Server 100 arranges data file object Ob3, which has the third highest degree of association, at a position remote from avatar Av1 by distance D3.

Thus, space provision system 1000 arranges, at a position with the highest visibility of user Ur1, the data file that is most likely to be the data file desired by user Ur1. Space provision system 1000 can express the magnitude of the degree of association using distance, thus causing user Ur1 to intuitively recognize the magnitude of the degree of association. In this way, space provision system 1000 allows data files, which have been searched for by a user, to be viewed in a more easy-to-understand manner in the virtual space, and accordingly, can improve user's convenience when the user searches for documents while conducting a discussion among a plurality of people.

In addition, as the data files that are most likely to be the data files desired by user Ur1 are displayed in descending order of visibility, space provision system 1000 can reduce the user Ur1's burden of searching for the desired data files. Further, user Ur2, who is immersed in the same virtual space, can visually recognize data file objects Ob1 to Ob12 via avatar Av2. This allows user Ur1 and user Ur2 to conduct a discussion while sharing the same document and efficiently collect information on research and development. In other words, space provision system 1000 can facilitate the exchange of opinions between user Ur1 and user Ur2.

### <Flowchart>

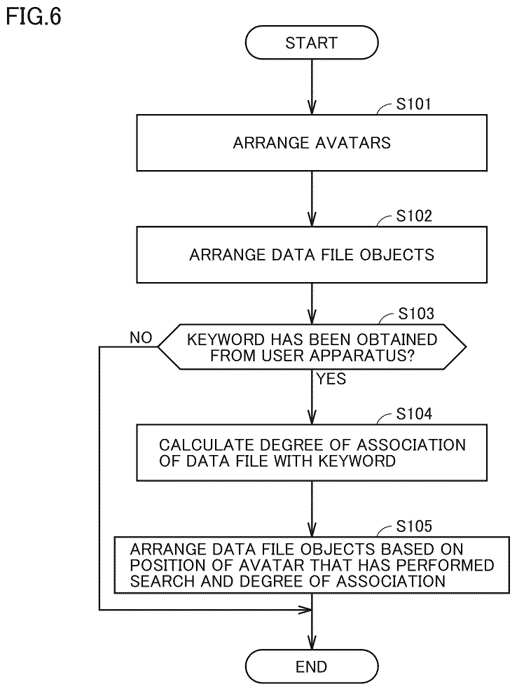

FIG. 6 is a flowchart for illustrating a procedure of arranging data file objects in Embodiment 1. The processing of the flowchart shown in FIG. 6 is stored as a space provision program 1041 in storage device 104 of server 100. In other words, the processing of the flowchart shown in FIG. 6 is implemented as processor 102 executes space provision program 1041 in storage device 104. Processor 102 repeatedly execute space provision program 1041 at predetermined intervals.

Server 100 arranges avatars Av1, Av2 corresponding to a plurality of users Ur1, Ur2, respectively, in a virtual space (step S101). In step S101, server 100 may rearrange avatars Av1, Av2 based on input from users Ur1, Ur2. This allows users Ur1, Ur2 to move avatars Av1, Av2 to any positions in the virtual space.

Server 100 arranges data file objects corresponding to all the data files included in data file group Dc100 in the virtual space (step S102). Before receiving a search command from the user, server 100 first arranges all the data file objects within range St1 included in the background.

Server 100 determines whether it has obtained a keyword from any of user apparatuses 200A, 200B (step S103). When a keyword has not been obtained from any of user apparatuses 200A, 200B (NO in step S103), server 100 ends the processing of the flowchart of FIG. 6. When a keyword has been obtained from any of user apparatuses 200A, 200B (YES in step S103), server 100 calculates the degree of association of each of all the data files included in data file group Dc100 with the keyword (step S104).

Server 100 determines the position of each data file object and arranges each data file object in accordance with the position of the avatar corresponding to the user that has performed a search and the degree of association calculated in step S104 (step S105). In other words, server 100 determines a reference position based on the position of the avatar, and based on the determined reference position and an evaluation value, determines the manner of displaying each data file object. The reference position, which is a position that serves as a reference for determining the position at which each data file object is arranged, is determined based on the position of the avatar that is a target for which each data file object is displayed. In the example of Embodiment 1, the position of avatar Av1 corresponding to user Ur1 who has performed a search is determined as the reference position. In the example of Embodiment 1, user Ur1 who has performed a search may correspond to the “specific user” in the present disclosure.

Thus, in space provision system 1000 in the present embodiment, the position of the virtual space at which the data file displayed as a search result is arranged is determined in accordance with the degree of association with the keyword. In this way, space provision system 1000 allows data files, which have been searched for by a user, to be viewed in a more easy-to-understand manner in the virtual space, and accordingly, can improve user's convenience when the user searches for documents while conducting a discussion among a plurality of people.

### Embodiment 2

Embodiment 1 has described an example in which the position of avatar Av1 corresponding to user Ur1 who has performed a search is determined as the reference position, and a data file object is arranged in the virtual space based on the determined reference position. However, server 100 may arrange data file objects in the virtual space while taking into account the position of avatar Av2 in addition to the position of avatar Av1. Embodiment 2 will describe a configuration in which the reference position is determined while taking into account the positions of both users Ur1, Ur2, and the data file objects are arranged.

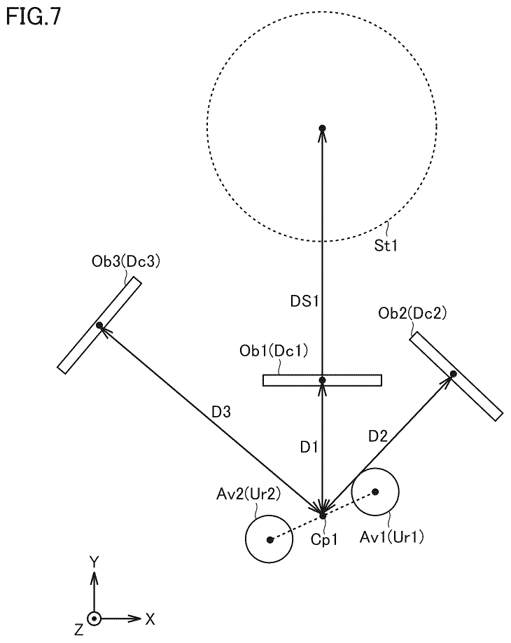

FIG. 7 is a diagram for illustrating an arrangement of objects as search results in Embodiment 2. In Embodiment 2, the description of the configuration overlapping that of space provision system 1000 of Embodiment 1 will not be repeated.

In Embodiment 2, data file objects Ob1 to Ob12 are arranged with a point Cp1 as the reference position. Point Cp1 is the midpoint in the straight-line distance between the position of avatar Av1 that is a target for which search results are displayed and the position of avatar Av2 that is a target for which search results are displayed. Server 100 in Embodiment 2 recognizes avatar Av1 that has performed a search and avatar Av2 that is arranged within a predetermined range from the position of avatar Av1 as avatars that are the targets for which search results are displayed. As in FIG. 4, data file objects Ob4 to Ob12 are not shown in FIG. 7.

In other words, distance D1 in FIG. 7 is the straight-line distance between the position of point Cp1 and the position of data file object Ob1. Distance D2 in FIG. 7 is the straight-line distance between the position of point Cp1 and the position of data file object Ob2. Distance D3 in FIG. 7 is the straight-line distance between the position of point Cp1 and the position of data file object Ob3. Distance DS1 in FIG. 7 is the straight-line distance between the position of point Cp1 and the position of range St1.

Thus, in Embodiment 2, point Cp1 is determined as the reference position while taking into account the position of avatar Av2 corresponding to user Ur2 in addition to the position of avatar Av1 corresponding to user Ur1 who has performed a search, and the positions at which data file objects Ob1 to Ob12 are arranged are determined based on the determined point Cp1. As a result, space provision system 1000 of Embodiment 2 can arrange data file objects Ob1 to Ob12 while taking into account not only the visibility of user Ur1 but also the visibility of user Ur2.

In the example of FIG. 7, the reference position is determined based on the position of avatar Av1 and the position of avatar Av2, and data file objects Ob1 to Ob3 are arranged. In space provision system 1000 of one aspect, data file objects Ob1 to Ob3 may be displayed relative to point Cp1 only when the distance between avatar Av1 and avatar Av2 is less than a predetermined distance determined in advance. Space provision system 1000 can thus arrange data file objects Ob1 to Ob3 at highly visible positions as seen from the positions of both avatars Av1, Av2. In the example of FIG. 7, avatar Av1 may correspond to the “first user object” in the present disclosure. Avatar Av2 may correspond to the “second user object” in the present disclosure.

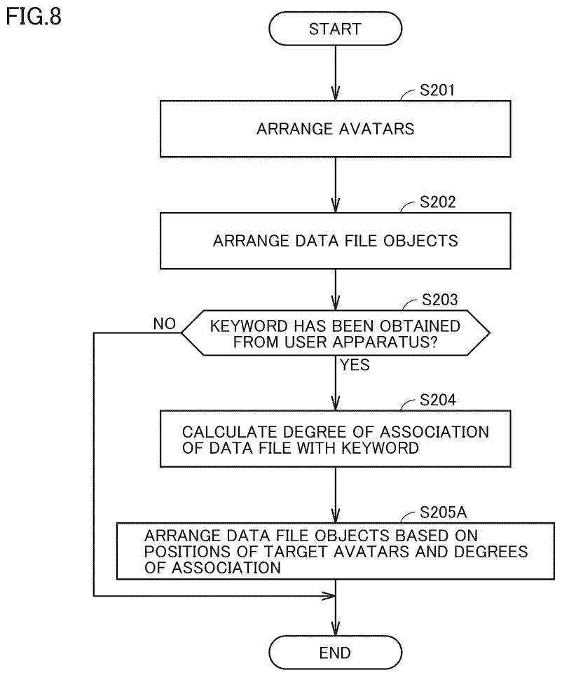

FIG. 8 is a flowchart for illustrating a procedure of arranging data file objects in Embodiment 2. Processing of steps S201, S202, S203, S204 of the flowchart in FIG. 8 is the same as that of steps S101, S102, S103, S104 of the flowchart in FIG. 6, description of which will not be repeated.

In Embodiment 2, after calculating the degree of association in step S204, server 100 arranges data file objects Ob1 to Ob12 based on the positions of a plurality of target avatars and the degrees of association calculated in step S204 (step S205A). The plurality of target avatars are avatars that have been determined by server 100 as the targets for which search results should be displayed. For example, server 100 recognizes the avatars corresponding to the users arranged within a predetermined range from the position of user Ur1 who has performed a search, as the avatars to which search results should be displayed.

In the example of Embodiment 2, server 100 recognizes avatars Av1, Av2 as the avatars for which search results should be displayed. Server 100 calculates point Cp1 that is the center of the arrangement of the plurality of avatars Av1, Av2, and arranges data file objects Ob1 to Ob12 based on the position of the calculated point Cp1 and the degrees of association.

Thus, server 100 of Embodiment 2 changes the manner of displaying data file objects Ob1 to Ob12 based on the position of avatar Av1 corresponding to user Ur1 who has performed a search, as well as the position of avatar Av2 of user Ur2 that is a target for which search results are displayed and the calculated degrees of association. As a result, in space provision system 1000 of Embodiment 2, data file objects Ob1 to Ob12 can be arranged while taking into account not only the visibility of user Ur1 but also the visibility of user Ur2. As in Embodiment 1, space provision system 1000 in Embodiment 2 allows the data files, which have been searched for by the user, to be viewed in a more easy-to-understand manner in the virtual space, and accordingly, can improve user's convenience when the user searches for documents while conducting a discussion among a plurality of people.

### Embodiment 3

Embodiment 1 has described an example in which user Ur1 performs a keyword search by inputting a keyword to user apparatus 200A. However, the method of obtaining a keyword may be any other method, and Embodiment 3 will describe a configuration in which the word that satisfies the condition is obtained as the keyword from the content of user Ur1's utterance. Embodiment 3 will not repeat the description of the configuration overlapping that of space provision system 1000 of Embodiment 2.

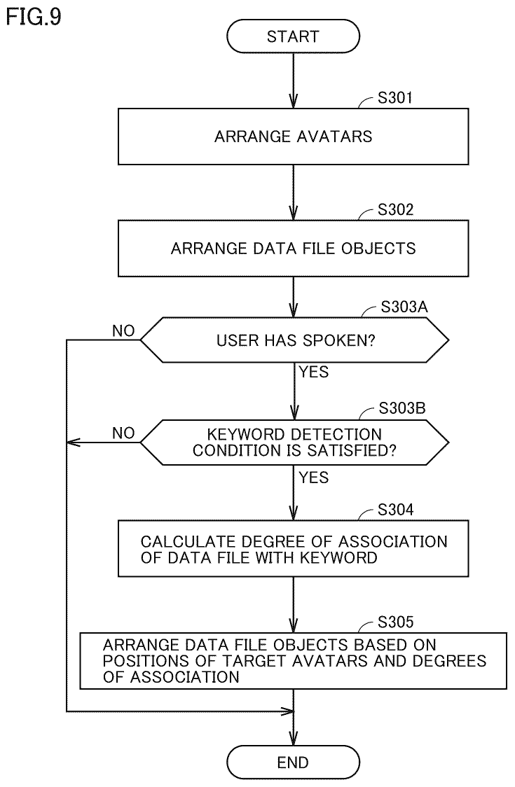

FIG. 9 is a flowchart for illustrating a procedure of arranging data file objects in Embodiment 3. Processing of steps S301, S302, S304, S305 of the flowchart in FIG. 9 is the same as that of steps S201, S202, S204, S205A of the flowchart in FIG. 8, description of which will not be repeated.

As shown in FIG. 9, server 100 arranges avatars Av1, Av2 and arranges all data file objects within range St1, and then, determines whether the user has spoken (step S303A). When the user has not spoken (NO in step S303A), server 100 ends the processing of the flowchart of FIG. 9.

When the user has spoken (YES in step S303A), server 100 determines the content of the user's utterance using utterance recognition and determines whether the keyword detection condition is satisfied (step S303B). The keyword detection condition is, for example, a condition that is satisfied as a specific word has been spoken by the user a predetermined number of times or more within a predetermined period. Alternatively, the keyword detection condition may be a condition that an instruction to perform a keyword search for a specific word is detected after the user has spoken the specific word.

When the keyword detection condition is not satisfied (NO in step S303B), server 100 ends the processing of the flowchart of FIG. 9. When the keyword detection condition is satisfied (YES in step S303B), server 100 calculates the degree of association of the data file with the keyword detected in step S303B (step S304).

Thus, space provision system 1000 of Embodiment 3 automatically obtains a keyword from the user's utterance. As a result, in Embodiment 3, search processing can be performed automatically without the user inputting a keyword, reducing user's burden. In Embodiment 3, search results can be displayed automatically in the natural flow of conversation between users. As in Embodiment 1, space provision system 1000 in Embodiment 3 allows data files, which have been searched for by a user, to be viewed in a more easy-to-understand manner in the virtual space, and accordingly, can improve user's convenience when the user searches for documents while conducting a discussion among a plurality of people.

### Embodiment 4

Embodiment 1 has described that in order to arrange data file objects corresponding to data files each having a high degree of association with a keyword at positions with high user visibility, the data file objects are arranged at positions close to the avatars. However, the display manner with high user visibility is not limited only to arranging data file objects at positions close to the avatars. Embodiment 4 will describe a configuration in which the sizes of data file objects corresponding to data files each having a high degree of association are changed.

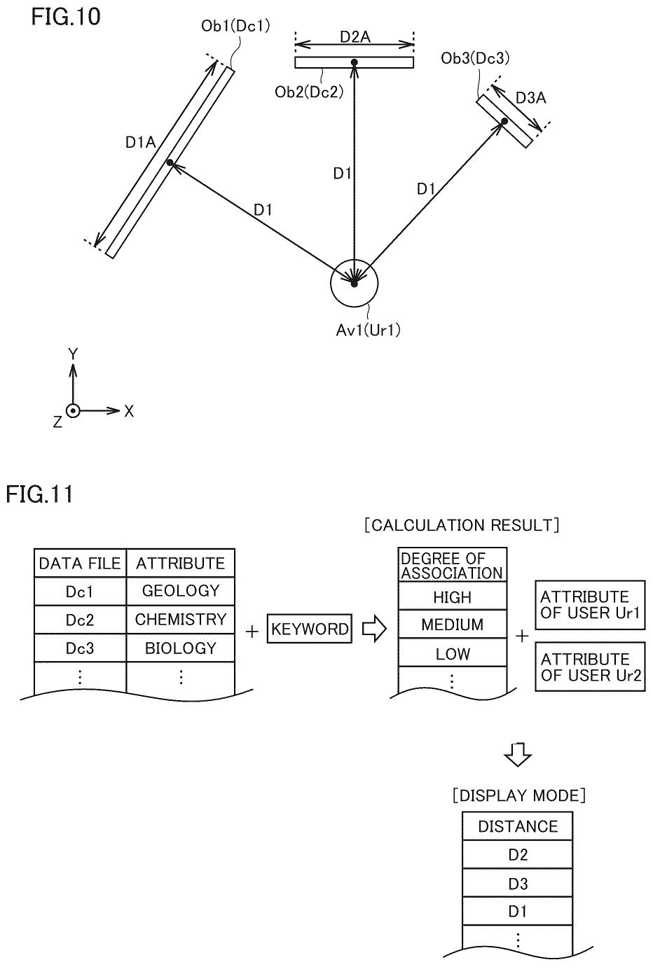

FIG. 10 is a diagram for illustrating an arrangement of objects as search results in Embodiment 4. In Embodiment 4, the description of the configuration overlapping that of space provision system 1000 of Embodiment 1 will not be repeated.

As shown in FIG. 10, data file objects Ob1 to Ob3 are arranged relative to the position of avatar Av1. As in Embodiment 1, in Embodiment 3, the degree of association of data file Dc1 with the keyword is “high”, the degree of association of data file Dc2 with the keyword is “medium”, and the degree of association of data file Dc3 with the keyword is “low”.

In the example of FIG. 10, server 100 arranges all of data file objects Ob1 to Ob3 at a distance D1 from the position of avatar Av1. In other words, data file objects Ob1 to Ob3 are arranged at the same distance from the position of avatar Av1.

In contrast, in Embodiment 4, data file objects Ob1 to Ob3 are arranged so as to be arranged in the virtual space in different sizes. More specifically, as shown in FIG. 10, the width of data file object Ob1 in the display direction is a width DIA. The width of data file object Ob2 in the display direction is a width D2A. The width of data file object Ob3 in the display direction is a width D3A. Of widths DIA to D3A, width DIA is the longest, and width D3A is the shortest.

The example of FIG. 10, which is a diagram as seen from the positive direction side of the Z axis, shows only the width of the data file object in the display direction, but the vertical length of the data file object in the display direction is also changed in accordance with the width. In other words, the display area included in the field of view of avatar Av1 is the largest in data file object Ob1 and is the smallest in data file object Ob3. When the display area of the data file object is large, the region that occupies the user's field of view is also large, thus improving the visibility of the data file object.

As described above, server 100 of Embodiment 4 displays data file object Ob1 larger than data file objects Ob2, Ob3. Space provision system 1000 of Embodiment 4 expresses the degree of association with the keyword using the size of the data file object, rather than the distance between avatar Av1 and the data file object. As in Embodiment 1, space provision system 1000 in Embodiment 4 allows data files, which have been searched for by a user, to be viewed in a more easy-to-understand manner in the virtual space, and accordingly, can improve user's convenience when the user searches for documents while conducting a discussion among a plurality of people.

### Embodiment 5

Embodiment 1 has described a technique of calculating, based on a keyword, the magnitude of the degree of association. However, the magnitude of the degree of association may also be calculated based on a factor other than a keyword. Embodiment 5 will describe an example in which the degree of association is calculated while taking into account an attribute of a user and an attribute of a data file.

FIG. 11 shows an example of determining the manner of displaying data files Dc1 to Dc12 in Embodiment 5. In Embodiment 5, description of the configuration overlapping that of space provision system 1000 of Embodiment 2 will not be repeated.

Space provision system 1000 in Embodiment 5 obtains user attribute information when users Ur1, Ur2 start to be immersed in the virtual space. The user attribute information may be, for example, the field of expertise, educational background, department name, and past research field of the user. Storage device 104 in Embodiment 5 stores the attribute information of the data file associated with each data file included in data file group Dc100. The attribute information of the data file may be the field to which the content of the data file is related, the field of expertise of the author of the data file, or the like.

When there is found a correlation between the attribute information associated with a data file and the attribute information of user Ur1, server 100 of Embodiment 5 arranges a data file object corresponding to the data file at a position with high user visibility. In the example of Embodiment 5, the field of expertise of user Ur1 is “pharmacy”, and the field of expertise of user Ur2 is “biology”. As shown in FIG. 11, server 100 in Embodiment 5 calculates, as distance D1, the distance between the position of data file object Ob3 corresponding to data file Dc3 in the same field of expertise as that of user Ur2 and the position of the avatar. In other words, server 100 in Embodiment 5 arranges data file object Ob3 corresponding to data file Dc3 at a position with the highest visibility.

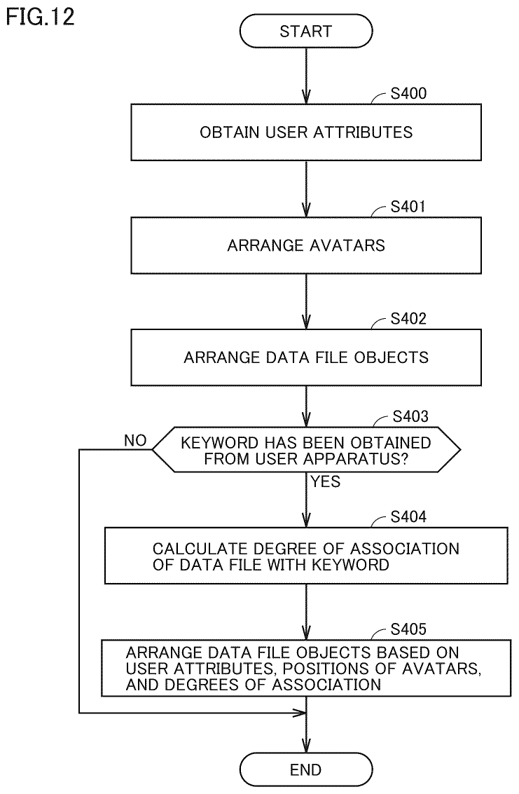

FIG. 12 is a flowchart for illustrating a procedure of arranging data file objects in Embodiment 5. Processing of steps S401, S402, S403, S404 of the flowchart in FIG. 12 is the same as that of steps S201, S202, S203, S204 of the flowchart in FIG. 8, description of which will not be repeated.

Before arranging a plurality of avatars, server 100 obtains attributes of users (step S400). For example, users Ur1, Ur2 input user attribute information to user apparatuses 200A, 200B, respectively, before being immersed in the virtual space. After calculating the degree of association, server 100 arranges data file objects Ob1 to Ob12 based on the attributes of the users, the positions of avatars Av1, Av2, and the calculated degree of association (step S405).

Thus, server 100 of Embodiment 5 obtains the attributes of the users and changes the manner of displaying the data file objects based on the attributes of the users. As a result, in space provision system 1000 of Embodiment 5, data files in fields in which the user has in-depth knowledge can be presented at positions with high visibility, leading to a more active discussion. As in Embodiment 1, space provision system 1000 in Embodiment 5 allows data files, which have been searched for by a user, to be viewed in a more easy-to-understand manner in the virtual space, and accordingly, can improve user's convenience when the user searches for documents while conducting a discussion among a plurality of people.

### Modification of Embodiment 2

Embodiment 2 has described an example in which data file objects Ob1 to Ob12 are arranged with point Cp1, which is the midpoint between the position of avatar Av1 and the position of avatar Av2, as the reference position. However, the reference position may be determined by any other technique. A modification of Embodiment 2 will describe first to third examples in which a reference position is determined while taking into account any other circumstance in addition to a position of an avatar that is a target for which search results are displayed.

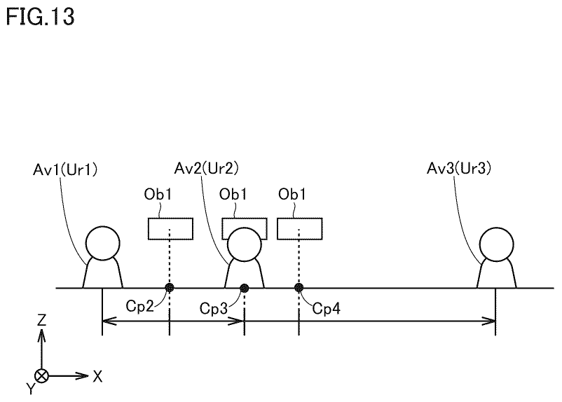

FIG. 13 shows an example of determining positions at which data file objects are arranged in the modification of Embodiment 2. In the modification of Embodiment 2, the description of the configuration overlapping that of space provision system 1000 of Embodiment 2 will not be repeated.

FIG. 13 shows a virtual space as viewed from the negative direction side of the Y axis. In the example of FIG. 13, an avatar Av3 corresponding to a user Ur3 is shown in addition to avatars Av1, Av2. Avatars Av1 to Av3 are arranged side by side in the X axis direction. Each of avatars Av1 to Av3 is arranged while facing the positive direction of the Y axis. In other words, the fields of view of users Ur1 to Ur3 are the fields of view in the virtual space when the users face the positive direction of the Y axis from the respective positions of avatars Av1 to Av3.

A point Cp2 is the midpoint between the position of avatar Av1 and the position of avatar Av2 in the X axis direction. A point Cp3 is the position of avatar Av2 in the X axis direction. A point Cp4 is the midpoint between the position of avatar Av1 and the position of avatar Av3 in the X axis direction.

The example of Embodiment 2 has described an example in which server 100 recognizes avatars arranged within a predetermined range from the position of the avatar that has performed a search, as avatars that are the targets for which search results are displayed. In the example of FIG. 13, a search is performed by avatar Av2 corresponding to user Ur2. In the example of FIG. 13, also, avatars Av1, Av3 are arranged relative to the position of user Ur2 within a range in which they can be recognized as targets for which display is performed.

In the first example in the modification of Embodiment 2, all of avatars Av1 to Av3 are arranged within the range in which they can be recognized as targets for which display is performed, and thus, all of avatars Av1 to Av3 are the targets for which search results are displayed. Server 100 determines, as the reference position, a position that is easily visible from the positions of all of avatars Av1 to Av3. In the example of FIG. 13, server 100 determines a position corresponding to point Cp4 as the reference position. As shown in FIG. 13, server 100 arranges data file objects Ob1 to Ob12 at positions corresponding to point Cp4. In the example of FIG. 13, data file objects Ob2 to Ob12 are not shown. In the example of FIG. 13, the example in which data file objects Ob1 to Ob12 are arranged while taking into account only the X axis direction is illustrated for simplify of the description, but server 100 may arrange data file objects Ob1 to Ob12 at positions that are easily visible from the positions of avatars Av1 to Av3 while taking into account the positions of avatars Av1 to Av3 in the Y axis direction or the Z axis direction.

In the second example in the modification of Embodiment 2, the avatar that is a target for which search results are displayed is determined based on the content of the conversation among avatars Av1 to Av3. In the second example in the modification of Embodiment 2, avatar Av3 is arranged within a predetermined range (a range in which an avatar can be recognized as a target for which display is performed) from the position of avatar Av2 that has performed a search, but avatar Av3 does not participate in the discussion conducted between avatars Av1, Av2. For example, avatar Av3 is an avatar that temporarily approaches avatars Av1, Av2 conducting a discussion while moving in the virtual space, which is an avatar that is not involved in the discussion conducted between avatars Av1, Av2.

In the second example in the modification of Embodiment 2, server 100 determines that avatar Av3 is not in conversation with avatars Av1, Av2 based on the content of utterance of avatars Av1 to Av3 obtained by server 100. More specifically, server 100 determines that avatar Av3 is not in conversation with avatars Av1, Av2 based on the amount of utterance of avatars Av1 to Av3, timing of utterance, whether the utterance is established as a conversation, or the like. Server 100 determines that only avatars Av1, Av2 are the targets for which search results are displayed, and arranges data file objects Ob1 to Ob12 at positions corresponding to point Cp2. This allows avatar Av3, which is not participating in the discussion, to be excluded from the targets for which display is performed, and allows data file objects Ob1 to Ob12 to be arranged at positions suitable for the positions of avatars Av1, Av2 for which search results need to be displayed.

In the third example in the modification of Example 2, as in the second example, avatar Av3 is arranged within a predetermined range from the position of avatar Av2 that has performed a search, but avatar Av3 is not participating in the discussion conducted between avatars Av1, Av2. Further, in the third example in the modification of Embodiment 2, a discussion is conducted between avatars Av1, Av2, but avatar Av1 is the one that provides an instruction to avatar Av2, and avatar Av2 is the one that views search results based on the instruction. More specifically, avatar Av1 is a superior (or teacher) of avatar Av2, and avatar Av2 is a subordinate (or student) of avatar Av1.

For example, a conversation is conducted between avatar Av1 and avatar Av2 for helping avatar Av2 view desired documents, and avatar Av1 does not wish to view search results. Avatar Av1 provides advice to avatar Av2 regarding the input of search information. Avatar Av2 inputs the search results based on the advice from avatar Av1. In this case, server 100 determines that only avatar Av2 is a target for which search results are displayed, based on the content of the utterance of avatars Av1, Av2, the attribute information (superior, subordinate) of avatars Av1, Av2, or the like.

As a result, server 100 arranges data file objects Ob1 to Ob12 at the positions corresponding to point Cp3. As a result, avatar Av3, which is not participating in the discussion, and avatar Av1, which does not wish to view the search results, can be excluded from the targets for which search results are displayed, and data file objects Ob1 to Ob12 can be arranged at positions suitable only for avatar Av2, for which search results need to be displayed. Further, in the third example in the modification of Embodiment 2, search information may be input by avatar Av1, which does not wish to view the search results. Server 100 may not determine, as the target for which search results are displayed, the avatar that has input the search information based on the content of utterance of the avatar. In this way, as in Embodiment 1, space provision system 1000 in the modification of Embodiment 2 allows data files, which have been searched for by a user, to be viewed in a more easy-to-understand manner in the virtual space, and accordingly, can improve user's convenience when the user searches for documents while conducting a discussion among a plurality of people.

Thus, in the modification of Embodiment 2, the avatar that is a target for which search results are displayed is determined from, for example, the content of utterance and attribute information of avatars Av1 to Av3, in addition to the positions of avatars Av1 to Av3. This allows the search results to be arranged at a position suitable for the avatar that needs to view the search results. In other words, as in Embodiment 1, space provision system 1000 in the modification of Embodiment 2 allows data files, which have been searched for by a user, to be viewed in a more easy-to-understand manner in the virtual space, and accordingly, can improve user's convenience when the user searches for documents while conducting a discussion among a plurality of people.

### <Other Modifications>

The following will describe various modifications to embodiments described above. The example of Embodiment 1 has described the example in which user apparatus 200 is a head-mounted display. However, user apparatus 200 may simply be a liquid crystal panel or an organic electro luminescence (EL) panel.

The example of Embodiment 1 has described that server 100 has storage device 104 that stores the data necessary for configuring a virtual space and a plurality of data files. However, storage device 104 may be provided separately from server 100. Storage device 104 only needs to be accessible from server 100 and may be located remotely from the position at which server 100 is arranged. In addition, server 100 may be arranged at the same location as that of any of user apparatuses 200A, 200B or may exist as a cloud server in a location remote from user apparatuses 200A, 200B.

The example of Embodiment 1 has described an example in which users Ur1, Ur2 are both researchers and user Ur1 and user Ur2 exchange opinions about their research with each other. However, the content of the communication conducted between users Ur1, Ur2 is not limited to the exchange of opinions, and may include various types of communication such as business talks, interviews, consultations, and presentations.

The example of Embodiment 1 has described an example in which network NW is the Internet, but network NW may also be a local area network, a wide area network, or the like.

The example of Embodiment 1 has described an example in which the data file is a technical document, but it may be any other document file, image data, or video data. In addition, Embodiment 1 has described an example in which data file group Dc100 includes 100 data files of technical documents, but the number of data files included in data file group Dc100 is not limited to 100 and may be 10, 50, 5,000, or several hundred thousand.

The example of Embodiment 1 has described an example in which server 100 performs a search based on one keyword in a keyword search. However, server 100 may perform a search based on a plurality of keywords, or the user may specify the maximum number of characters in a document, an author name of a document, or the like, in addition to the keyword.

The example of Embodiment 1 has described that data file objects corresponding to data files each having a degree of association less than a predetermined threshold are collected within range St1. The data file object within range St1 is in the form of a document, and information indicating part of the content of an actual data file object may be displayed. For example, the plurality of data file objects within range St1 may be displayed such that the cover, title, or the content of abstract of each data file object is recognizable. Thus, space provision system 1000 can cause user Ur2 to grasp that each of the data file objects included in range St1 corresponds to an actual technical document.

The plurality of data file objects within range St1 may be constantly moving within range St1. For example, server 100 may cause the plurality of data file objects to rotate so as to whirl within range St1. Thus, space provision system 1000 can emphasize that data file objects corresponding to technical documents that are not displayed as search results exist within range St1.

Further, data file objects within range St1 may be displayed such that information about data file objects is recognizable. For example, a predetermined color may be applied to data file objects corresponding to data files within the last one month. Alternatively, different colors may be applied to data file objects according to the year in which a document was created. This allows users to easily grasp the date on which the data file was created as a document. In addition, server 100 may apply different colors to data file objects in accordance with the publisher, author, or field of the technical document. Thus, space provision system 1000 can cause users to easily grasp information about data file objects arranged within range St1.

The example of FIG. 3 shows an example in which data file objects Ob1 to Ob12, which are the search results, are arranged in front of avatar Av1. In other words, FIG. 3 shows the virtual space in the state after search processing. As described in step S102 of FIG. 6, server 100 collects and arranges data file objects corresponding to all data files within range St1 in advance before the user performs search processing. In one aspect, however, server 100 may start arranging data file objects, which have a degree of association less than or equal to the threshold, in range St1 based on the user having performed search processing, without arranging any data file objects within range St1 in advance before search processing is performed.

As described in Embodiment 1, when data file objects are arranged in range St1 in advance before search processing is performed, server 100 may display an animation in which data file objects having a degree of association greater than or equal to the threshold are moved from range St1 to the front of avatar Av1, after calculating the search results.

The example of Embodiment 2 has described an example in which data file objects Ob1 to Ob12 are arranged based on the midpoint between two users Ur1, Ur2. When the number of users who are immersed in the virtual space is three or more, server 100 obtains the positions of the avatars corresponding to the three users on the XY plane. Server 100 may determine the center of gravity of the positions of the three avatars as point Cp1. Server 100 may determine the position of point Cp1 by any other technique, for example, may determine the center point of a circle that passes through the positions of all of the three avatars as point Cp1. In a more specific example, server 100 may prepare a classroom in the virtual space, arrange avatars as 30 students in the classroom, and determine the center point of the classroom as point Cp1.

Embodiment 2 has described an example in which server 100 arranges data file objects Ob1 to Ob12 relative to point Cp1. Server 100 may arrange data file objects Ob1 to Ob12 while taking into account the direction that avatars Av1, Av2 face. For example, when partial regions overlap each other in the virtual space within the fields of view of avatars Av1, Av2, server 100 may arrange data file objects Ob1 to Ob12 in the overlapping region. In other words, server 100 may display data file objects Ob1 to Ob12 in the region that is commonly included in the fields of view of avatars Av1, Av2.

The technique of calculating a degree of association and the technique of determining a position at which a data file object is arranged according to the degree of association may be changed as appropriate by the user or the administrator of server 100.

The example of Embodiment 1 has described that server 100 arranges a data file object at a highly visible position by arranging the data file object at a position close to an avatar. When any other object has already been arranged around avatar Av1, server 100 may arrange a data file object while taking into account the position of the other object. In other words, when there is any other object between avatar Av1 and a data file object having a high degree of association, server 100 may change the position of the data file object having a high degree of association and rearrange the data file object having a high degree of association at a highly visible position. Thus, space provision system 1000 can arrange data file objects while taking into account the presence of an object that may obstruct the user's field of view.

In addition, some of the processing steps in the flowcharts described with reference to FIGS. 6, 8, 9, 12 may be performed by an apparatus external to server 100. For example, processing of obtaining a keyword and calculating a degree of association with the keyword, which are shown as steps S103, S104 in FIG. 6, may be performed by user apparatus 200. In addition, the order of the processing steps in the flowcharts described with reference to FIGS. 6, 8, 9, 12 is not limited to the order shown in FIGS. 6, 8, 9, 12. For example, step S102 may be performed before step S101 in FIG. 6.

The examples of Embodiments 1 to 5 have described examples in which a user performing a search is immersed in the virtual space. In other words, an avatar corresponding to a user performing a search is arranged in the virtual space. However, the user performing a search does not have to be immersed in the virtual space. For example, avatar Av1, which is a target for which search results are displayed, may be talking with an external user via voice call, and a search command may be input by the external user. Also in this case, server 100 determines only avatar Av1 as a target for which search results are displayed, based on the content of the user's utterance and the fact that an avatar corresponding to the user that has input the search command is not arranged in the virtual space.

The examples of Embodiments 1 to 5 have described examples in which the manner of displaying search results changes in accordance with the degree of association with search information as an evaluation value. However, the evaluation value may include an indicator other than the degree of association with search information. For example, the evaluation value may change the manner of displaying each data file object in accordance with the number of times each data file has been cited in other papers or the number of times it has been viewed in the past. More specifically, server 100 may arrange even a data file having a low degree of association with search information, which has been cited or viewed many times in the past, at a position with high user visibility than a data file having a high degree of association with search information.

### [Aspects]

It will be understood by a person skilled in the art that the illustrative embodiments described above are specific examples of the following aspects.

(Clause 1) A space provision system according to an aspect is a space provision system that provides a virtual space to a plurality of users. The space provision system includes a plurality of user apparatuses respectively used by the plurality of users, and a server that provides the virtual space to the plurality of user apparatuses. The server arranges a plurality of data file objects respectively corresponding to a plurality of data files in the virtual space, arranges a plurality of user objects respectively corresponding to the plurality of users in the virtual space, obtains search information for searching for a specific data file from the plurality of data files, and determines a reference position based on positions of the plurality of user objects, and based on the determined reference position and an evaluation value for search information in each of the plurality of data files, determines a manner of displaying the plurality of data file objects to be arranged.

The space provision system according to clause 1 allows data files, which have been searched for by a user, to be viewed in a more easy-to-understand manner in the virtual space, and accordingly, can improve user's convenience when the user searches for documents while conducting a discussion among a plurality of people.

(Clause 2) In the space provision system according to clause 1, the server calculates, based on the search information, a degree of association of each of the plurality of data files with the search information.

The space provision system according to clause 2 can determine the manner of displaying data file objects using the degree of association.

(Clause 3) In the space provision system according to clause 2, the plurality of data file objects include a first data file object corresponding to a first data file, and a second data file object corresponding to a second data file having the degree of association lower than the degree of association of the first data file. The server obtains the search information from a specific user apparatus used by a specific user, and arranges the first data file object at a position with higher visibility of the specific user than that of the second data file object in the virtual space.

The space provision system according to clause 3 can arrange, at highly visible positions, data file objects corresponding to data files having a high degree of association with search information, thus reducing the user's burden of searching for a desired data file.

(Clause 4) In the space provision system according to clause 3, the server arranges the first data file object at a position closer to a specific user object corresponding to the specific user than that of the second data file object.

The space provision system according to clause 4 can arrange a data file object at a position close to an avatar, thus arranging the data file object at a highly visible position.

(Clause 5) In the space provision system according to clause 3 or 4, the server displays the first data file object larger than the second data file object.

The space provision system according to clause 5 can display a data file object in a larger size, thus increasing the visibility of the data file object.

(Clause 6) In the space provision system according to any one of clauses 3 to 5, the server collects and arranges the plurality of data file objects within a predetermined range, the plurality of data file objects corresponding to the plurality of data files each having the degree of association less than a threshold.

The space provision system according to clause 6 can arrange, in the virtual space, data file objects corresponding to all data files stored in a storage device, thus expressing technical capabilities and a data volume of an organization that owns these data files.

(Clause 7) In the space provision system according to clause 6, the predetermined range is located in a background of the virtual space as seen from the specific user.

The space provision system according to clause 7 can display the predetermined range in the background of search results, thus effectively displaying both the search results and data file objects arranged within range St1 to the user.

(Clause 8) In the space provision system according to any one of clauses 2 to 7, the plurality of user objects include a first user object corresponding to a first user, and a second user object corresponding to a second user. The server changes the manner of displaying the plurality of data file objects based on a position of the first user object and the degree of association.

The space provision system according to clause 8 can improve the visibility of one user that is a target for which search results are displayed.

(Clause 9) In the space provision system according to any one of clauses 2 to 7, the plurality of user objects include a first user object corresponding to a first user, and a second user object corresponding to a second user. The server changes the manner of displaying the plurality of data file objects based on a position determined based on a position of the first user object and a position of the second user object, and the degree of association.

The space provision system according to clause 9 can improve the visibility of all users that are targets for which search results are displayed.

(Clause 10) In the space provision system according to any one of clauses 3 to 9, the specific user apparatus further includes an input device that obtains utterances of the users. The server obtains the search information from the specific user apparatus based on the utterance obtained by the input device.

The space provision system according to clause 10 can automatically extract a keyword used for keyword search based on the user's utterance, thus reducing the user's burden of issuing a keyword search command.

(Clause 11) In the space provision system according to any one of clauses 3 to 10, the server obtains attribute data indicating an attribute of the specific user, and changes, further based on the attribute data, the manner of displaying the plurality of data file objects.

The space provision system according to clause 11 can determine data files to be displayed in the search results while taking into account the attribute data of the user, leading to a more active discussion.

(Clause 12) In the space provision system according to clause 11, the attribute data indicates a field of expertise or an educational background of the specific user.

The space provision system according to clause 12 can more easily display data files related to the field of expertise or educational background of the user as search results.

(Clause 13) In the space provision system according to any one of clauses 1 to 12, the plurality of data files include a data file of at least one of a document, an image, and a video.

The space provision system according to clause 13 can display a technical document, an image, or a video as a search result.

(Clause 14) In the space provision system according to any one of clauses 1 to 13, the plurality of data files include a data file of a technical document, and the search information includes a keyword included in the technical document.

The space provision system according to clause 14 can search for a technical document by keyword search.

(Clause 15) A server according to an aspect is a server that provides a virtual space to a plurality of user apparatuses respectively used by a plurality of users. The server includes a storage device that stores a plurality of data files, and a control unit that controls an object arranged in the virtual space. The control unit arranges a plurality of data file objects respectively corresponding to the plurality of data files in the virtual space, arranges a plurality of user objects respectively corresponding to the plurality of users in the virtual space, obtains search information for searching for a specific data file from the plurality of data files, and determines a reference position based on positions of the plurality of user objects, and based on the determined reference position and an evaluation value for search information in each of the plurality of data files, determines a manner of displaying the plurality of data file objects to be arranged.

The server according to clause 15 allows data files, which have been searched for by a user, to be viewed in a more easy-to-understand manner in the virtual space, and accordingly, can improve user's convenience when the user searches for documents while conducting a discussion among a plurality of people.

(Clause 16) A space provision method according to an aspect is a space provision method of providing a virtual space to a plurality of user apparatuses respectively used by a plurality of users. The space provision method includes, as processing to be performed by a computer: arranging a plurality of data file objects respectively corresponding to a plurality of data files in the virtual space; arranging a plurality of user objects respectively corresponding to the plurality of users in the virtual space; obtaining search information for searching for a specific data file from the plurality of data files; and determining a reference position based on positions of the plurality of user objects, and based on the determined reference position and an evaluation value for search information in each of the plurality of data files, determining a manner of displaying the plurality of data file objects to be arranged.

The space provision system according to clause 16 allows data files, which have been searched for by a user, to be viewed in a more easy-to-understand manner in the virtual space, and accordingly, can improve user's convenience when the user searches for documents while conducting a discussion among a plurality of people.

(Clause 17) A space provision program according to an aspect is a space provision program that provides a virtual space to a plurality of user apparatuses respectively used by a plurality of users. The space provision program causes a computer to: arrange a plurality of data file objects respectively corresponding to a plurality of data files in the virtual space; arrange a plurality of user objects respectively corresponding to the plurality of users in the virtual space; obtain search information for searching for a specific data file from the plurality of data files; and determine a reference position based on positions of the plurality of user objects, and based on the determined reference position and an evaluation value for search information in each of the plurality of data files, determine a manner of displaying the plurality of data file objects to be arranged.

The space provision program according to clause 17 allows data files, which have been searched for by a user, to be viewed in a more easy-to-understand manner in the virtual space, and accordingly, can improve user's convenience when the user searches for documents while conducting a discussion among a plurality of people.

Although embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. A space provision system configured to provide a virtual space to a plurality of users, the space provision system comprising:
a plurality of user apparatuses respectively used by the plurality of users; and
a server that provides the virtual space to the plurality of user apparatuses,
wherein the server is configured to
arrange a plurality of data file objects respectively corresponding to a plurality of data files in the virtual space,
arrange a plurality of user objects respectively corresponding to the plurality of users in the virtual space,
obtain search information for searching for a specific data file from the plurality of data files,
determine a reference position based on positions of the plurality of user objects, and
based on the determined reference position and an evaluation value for search information in each of the plurality of data files, determine a manner of displaying the plurality of data file objects to be arranged.

2. The space provision system according to claim 1, wherein the server is configured to calculate, based on the search information, a degree of association of each of the plurality of data files with the search information.

3. The space provision system according to claim 2, wherein
the plurality of data file objects include
a first data file object corresponding to a first data file, and
a second data file object corresponding to a second data file having the degree of association lower than the degree of association of the first data file, and
the server is configured to
obtain the search information from a specific user apparatus used by a specific user, and
arrange the first data file object at a position with higher visibility of the specific user than that of the second data file object in the virtual space.

4. The space provision system according to claim 3, wherein the server is configured to arrange the first data file object at a position closer to a specific user object corresponding to the specific user than that of the second data file object.

5. The space provision system according to claim 3, wherein the server is configured to display the first data file object larger than the second data file object.

6. The space provision system according to claim 3, wherein the server is configured to collect and arrange the plurality of data file objects within a predetermined range in the virtual space, the plurality of data file objects corresponding to the plurality of data files each having the degree of association less than a predetermined threshold.

7. The space provision system according to claim 6, wherein the predetermined range is located in a background of the virtual space as seen from the specific user.

8. The space provision system according to claim 2, wherein
the plurality of user objects include
a first user object corresponding to a first user, and
a second user object corresponding to a second user, and
the server is configured to change the manner of displaying the plurality of data file objects based on a position of the first user object and the degree of association.

9. The space provision system according to claim 2, wherein
the plurality of user objects include
a first user object corresponding to a first user, and
a second user object corresponding to a second user, and
the server is configured to change the manner of displaying the plurality of data file objects based on a position determined based on a position of the first user object and a position of the second user object, and the degree of association.

10. The space provision system according to claim 3, wherein
the specific user apparatus further includes an input device that obtains utterances of the users, and
the server is configured to obtain the search information from the specific user apparatus based on the utterances obtained by the input device.

11. The space provision system according to claim 3, wherein the server is configured to
obtain attribute data indicating an attribute of the specific user, and
change, further based on the attribute data, the manner of displaying the plurality of data file objects.

12. The space provision system according to claim 11, wherein the attribute data indicates a field of expertise or an educational background of the specific user.

13. The space provision system according to claim 1, wherein the plurality of data files include a data file of at least one of a document, an image, and a video.

14. The space provision system according to claim 1, wherein
the plurality of data files include a data file of a technical document, and
the search information includes a keyword included in the technical document.

15. A server that provides a virtual space to a plurality of user apparatuses respectively used by a plurality of users, the server comprising:
a storage device configured to store a plurality of data files; and
a control unit configured to control an object arranged in the virtual space,
wherein the control unit is configured to
arrange a plurality of data file objects respectively corresponding to the plurality of data files in the virtual space,
arrange a plurality of user objects respectively corresponding to the plurality of users in the virtual space,
obtain search information for searching for a specific data file from the plurality of data files,
determine a reference position based on positions of the plurality of user objects, and
based on the determined reference position and an evaluation value for search information in each of the plurality of data files, determine a manner of displaying the plurality of data file objects to be arranged.

16. A space provision method of providing a virtual space to a plurality of user apparatuses respectively used by a plurality of users, the space provision method comprising, as processing to be performed by a computer:
arranging a plurality of data file objects respectively corresponding to a plurality of data files in the virtual space;
arranging a plurality of user objects respectively corresponding to the plurality of users in the virtual space;
obtaining search information for searching for a specific data file from the plurality of data files; and
determining a reference position based on positions of the plurality of user objects, and based on the determined reference position and an evaluation value for search information in each of the plurality of data files, determining a manner of displaying the plurality of data file objects to be arranged.
